(19) United States
(12) Patent Application Publication
(10) Pub. No.: US 2009/0171791 A1
(43) Pub. Date: Jul. 2, 2009

(54) METHOD OF ADVERTISING

(76) Inventor: Afser Shariff, Toledo, OH (US)

Correspondence Address: FRASER CLEMENS MARTIN & MILLER LLC, 28366 KENSINGTON LANE, PERRYSBURG, OH, 43551, US

(21) Appl. No.: 12/345,051

(22) Filed: Dec. 29, 2008

Related U.S. Application Data
(60) Provisional application No. 61/017,970, filed on Dec. 31, 2007.

(51) Int. Cl. G06Q 30/00; G06Q 50/00; G06Q 40/00

(52) U.S. Cl. 705/14; 705/2; 705/37

(57) ABSTRACT

A method of advertising is disclosed, and more particularly, a method for the targeted advertising of products and services to the visiting customers/clients of a business having a waiting area including the steps of providing a network in electronic communication with a source of media content in the waiting area, compiling information related to a customer/client visiting the business, and directing media content through the network to the customer/client in the waiting area based on the information related to the visiting customer/client.

### CROSS-REFERENCE TO RELATED APPLICATION

This application claims the benefit of U.S. Provisional Patent Application Ser. No. 61/017,970 filed on Dec. 31, 2007.

### FIELD OF THE INVENTION

The present invention relates to a method of advertising and more specifically, to a method for the targeted advertising of products and services to the visiting customers/clients of a business.

### BACKGROUND OF THE INVENTION

The typical sales model for companies in customer/client-based or patient-based fields, such as pharmaceutical companies, medical device manufacturers, and other related companies, involves a sales representative to provide information concerning a product or service to physicians during direct encounters. In a medical office, the sales representative model requires detailed interaction between a physician and the sales representative (known as “detailing”). Given the hectic schedule of physicians, the typical meeting between the sales representative and physician lasts less than five minutes. Accordingly, the efforts of the sales representative are largely ineffective as the physician may not receive enough relevant information to make an informed decision about the product or service. A physician may not be able to provide an informed recommendation for a product or service given the large number of products or services and information available and the large number of sales representatives that may meet with a physician. Therefore, the intended beneficiary of the product or service, the patient, may never be informed of or prescribed the product or service. Given that businesses are becoming more specialized, a larger number of highly skilled sales representatives are required. Specifically for a medical office, newer pharmaceuticals and devices are targeted for specific disease treatments and concomitantly require a higher level of skilled and trained sales representatives.

To address the inadequacies with sales representative meetings with businesses, advertisers have developed a technique known as electronic detailing or e-detailing. e-Detailing is a technology-based solution to provide product or service information and promotional material to businesses that involves multiple channels of interaction to produce product or service information, such as the internet, video conferencing, and the like. Business and professional personnel are able to learn information about relevant product or service information at the convenience of the personnel. e-Detailing is a relatively inexpensive and effective approach that can complement traditional detailing by sales representatives.

However, both conventional detailing and e-detailing require someone in the business to recall a large number of specialized products or services, as well as the issues the products and services are designed to address. It is incumbent upon the business to introduce or recommend a particular product or service to an appropriate customer/client. Additionally, detailing and e-detailing require the business to set aside time to meet with a sales representative for follow-up or additional information, thereby costing the business additional time and money.

When a customer/client visits a business, they are often required to wait in a waiting area. A typical business will stock the waiting area with magazines and books or provide a television with access to local programming or cable to provide entertainment. The waiting customer/client is a captive audience that has remained largely underutilized for targeted advertising.

Accordingly, it would be desirable to develop a method of targeted advertising of products and services to the visiting customers/clients of a business.

### SUMMARY OF THE INVENTION

Concordant and congruous with the present invention, it is an objective to develop a method of targeted advertising of products and services to the visiting customers/clients of a business while maximizing the profits of the business.

In a first embodiment, the method of advertising includes the steps of providing a business having a waiting area for customers/clients; providing a network in electronic communication with a source of media content; compiling information related to a customer/client visiting the waiting area of the business; and directing a selected portion of the media content through the network to a customer/client in the waiting area of the business based on the information related to the visiting customer/client.

In a second embodiment, the method of advertising includes the steps of providing a business having a waiting area for customers/clients; providing a network in electronic communication with a source of media content; compiling information related to a customer/client visiting the business, wherein the information is at least one of information regarding the reason for the custom/client visit; information regarding the business; information regarding current news and events; information regarding the field of the business; and information regarding the interests, hobbies, demographics, gender, and age of the customer/client; and directing a selected portion of the media content through the network to the customer/client in the waiting area of the business based on the information related to the visiting customer/client.

In a third embodiment, the method of advertising includes the steps of: providing a medical office having a waiting area for perspective patients; providing a network in electronic communication with a source of advertisements of a third party; compiling information related to a patient visiting the medical office; and directing a selected portion of the advertisements through the network to a patient in the waiting area of the medical office based on the information related to the visiting patient, wherein the medical office is a point of sale for products advertised and schedules services advertised.

### DETAILED DESCRIPTION OF THE PREFERRED EMBODIMENT

The following detailed description describes and illustrates various exemplary embodiments of the invention. The description serves to enable one skilled in the art to use the invention, and is not intended to limit the scope of the invention in any manner. In respect of the method disclosed, the steps presented are exemplary in nature, and thus, the order of the steps is not necessary or critical.

The method described herein is directed to a method of targeted advertising of products and services to the visiting customers/clients of a business. It is understood that methods similar to those described herein may be adapted for use by service providers or other businesses having a waiting area such as, for example, a medical office, a hospital, an auto repair shop, a law firm, or an accounting firm, for example.

The method contemplates using an advertising network connected to a source of information such as a computer, the internet, and a server containing media content, for example. The advertising network may include a television, a radio network, a second computer, a portable electronic device such as a portable television and an electronic journal or notebook, and a combination thereof, for example. The media content is broadcast over the network to a visiting customer/client of a business while captive in a waiting area. The customer/client may view a targeted advertisement in video format from the television or streaming video on the computer; in a sound format through the radio network or sound files from the computer terminal; or in print on the portable electronic device or a webpage on the computer terminal.

The business-related media content displayed on the network is determined by the business. The business may purchase media content, develop and use business-created content, obtain free media content, or a combination thereof for display on the network. The business may select the media content and organize it to determine the order in which it is broadcast during the course of day based on the particular customers/clients visiting the business. The content may include information regarding the nature of the visit of the customer/client to the business; information specifically related to the business; current news and events; information related to the overall field of the business; and the like.

In addition to selecting the business-related media content displayed on the network, the business may select paid advertisements. Advertisers desirous of marketing to a captive audience would pay the business for a desired amount of advertising time, a particular time frame for advertising, and advertising to a particular market segment, as mutually agreed upon with the business. A particular market segment may mean all customers/clients sharing a common demographic, such as age group or gender, and all people visiting the business for a common, particular reason, such as a personal injury if the business is a law firm or for sleep apnea if the business is a physician. Advertising time may be sold to advertisers by selling a particular time frame or season, for example to a pharmaceutical company during flu season, or the advertising may be sold on a day-by-day basis based on the customers/clients scheduled to visit the business. The advertising time may be auctioned between competing advertisers, thereby maximizing revenue for the business. The benefit of auctioning a particular time period to a third-party advertiser permits the advertiser to market the product or service directly to consumers without incurring the time and costs related to detailing the targeted business with the presence of a service representative.

Personal information related to the customer/client such as hobbies, interests, familial demographics, age, gender and the like may be utilized to determine the content and advertisements broadcast to a particular customer/client. It is understood that the business may engage a third-party to maintain patient information and determine the content and advertisements for each customer/client visiting the business on a day-to-day basis. By matching the information for a particular customer/client with the content and advertisements available on the computer, the internet, or the media server, the content and advertisements may be timed to broadcast on the network for the duration of the customer's/client's visit to the business.

The business may also sell the advertised products or services directly or via mail delivery, thereby creating a new point of sale for the client/customer. By selling the product, the business may collect a transaction fee or profit from sales in addition to the revenue received from selling the advertising time to the advertisers. If a service is advertised and desired by the customer/client, the business may schedule the services for the advertiser and/or receive a referral fee for each successful referral to the advertising service provider.

### EXAMPLE

The office of an Ear, Nose, and Throat (ENT) physician typically maintains a list of patients scheduled through the course of the day. The ENT office determines the order of the content and the advertisements to be broadcast throughout the day based on the appointment time of each patient, the malady for which the patient is being treated, as well as the age, sex, hobbies, and interests of the patient. The ENT office may engage a third-party host to compile the information related to each patient and determine the broadcasting schedule of the content and advertisements based thereon. The third-party may then contact advertisers and offer the particular time slot for sale, or an auction between advertising competitors for the particular time slot may be initiated with the highest bid winning the right to advertise during the specified time period. If no bid is received, the third-party may offer the time slot to an advertiser of a product or service unrelated to the patient or an advertisement of the services of the ENT office may be broadcast.

For example, at 8:45 AM a patient with a snoring disorder may have an appointment; at 9:00 AM a patient who is a smoker and may have a cancer related thereto may have an appointment; and at 9:15 a child with tonsillitis may have an appointment. For the 8:45 AM appointment, the advertisers bidding for the time period may be companies that produce sleep-aid and snore-reducing products or labs doing sleep studies; for the 9:00 AM appointment, the advertisements may be nicotine gum companies, nicotine patch companies, pharmaceutical companies, and the like; and for the 9:15 AM appointment, the advertisers may be retailers selling children's clothing or toys.

Based on the advertisements, the ENT office may serve as the point of sale for an advertised product such as the brand of nicotine gum or patch advertised, the toy advertised to the child, and the like. Also, the ENT office may process the payment for a product that is not in stock and have it delivered to the patient's home. If the patient desires a particular service that was advertised, the ENT office may issue a referral for the patient; schedule the service; and take payment for any future services to be rendered, as desired. Incentives such as discounts or coupons may be offered at the ENT office to induce purchases and immediate payment.

In accordance with the provisions of the patent statutes, the present invention has been described in what is considered to represent its preferred embodiment. However, it should be understood that the invention can be practiced otherwise than as specifically illustrated and described without departing from its spirit or scope.

What is claimed is:

1. A method of advertising including the steps of:
providing a business having a waiting area for customers/clients;
providing a network in electronic communication with a source of media content;
compiling information related to a customer/client visiting the waiting area of the business; and
directing a selected portion of the media content through the network to a customer/client in the waiting area of the business based on the information related to the visiting customer/client.

2. The method of advertising of claim 1, wherein the business is one of a medical office, a hospital, an auto-repair shop, a law firm, and an accounting firm.

3. The method of advertising of claim 1, wherein the network includes at least one of a television, a radio, a computer, and a portable electronic device.

4. The method of advertising of claim 1, wherein the source of information is at least one of a computer, the internet, and a media server.

5. The method of advertising of claim 1, wherein the media content is at least one of media content purchased by the business, media content developed by the business, and free media content obtained by the business.

6. The method of advertising of claim 1, wherein the media content is a paid advertisement of a third party.

7. The method of advertising of claim 6, wherein a cost of the advertisement is determined by an auction process.

8. The method of advertising of claim 6, wherein the third party pays for a desired time frame for showing the advertisement.

9. The method of advertising of claim 6, wherein the third party pays for a desired amount of time for showing the advertisement.

10. The method of advertising of claim 6, wherein the third party pays for a desired market segment to which the advertisement is directed.

11. The method of advertising of claim 6, wherein the third party pays for a desired season for showing the advertisement.

12. The method of advertising of claim 6, wherein the business is a point of sale for products advertised by the third party.

13. The method of advertising of claim 6, wherein the business schedules services advertised by the third party.

14. The method of advertising of claim 1, wherein information related to a customer/client visiting the business is at least one of information regarding the reason for the custom/client visit; information regarding the business; information regarding current news and events; information regarding the field of the business; and information regarding the interests, hobbies, demographics, gender, and age of the customer/client.

15. The method of advertising of claim 14, wherein the information is related to the customer/client visiting the business is compiled and organized by a third-party host.

16. The method of advertising of claim 1, further comprising the step of organizing the media content based on the time the customer/client is scheduled to visit the business.

17. A method of advertising including the steps of:
providing a business having a waiting area for customers/clients;
providing a network in electronic communication with a source of media content;
compiling information related to a customer/client visiting the business, wherein the information is at least one of information regarding the reason for the custom/client visit; information regarding the business;
information regarding current news and events; information regarding the field of the business; and information regarding the interests, hobbies, demographics, gender, and age of the customer/client; and
directing a selected portion of the media content through the network to the customer/client in the waiting area of the business based on the information related to the visiting customer/client.

18. The method of advertising of claim 17, further comprising the step of organizing the media content based on the time the customer/client is scheduled to visit the business.

19. The method of advertising of claim 17, wherein the media content is a paid advertisement of a third party.

20. A method of advertising including the steps of:
providing a medical office having a waiting area for perspective patients;
providing a network in electronic communication with a source of advertisements of a third party;
compiling information related to a patient visiting the medical office; and
directing a selected portion of the advertisements through the network to a patient in the waiting area of the medical office based on the information related to the visiting patient, wherein the medical office is a point of sale for products advertised and schedules services advertised.
